(19) United States
(12) Patent Application Publication
(10) Pub. No.: US 2026/0062148 A1
(43) Pub. Date: Mar. 5, 2026

(54) B-52 Electronic Warfare Pressure Test Set

(71) Applicant: Fernando De La Pena Llaca, Houston, TX (US)

(72) Inventor: Fernando De La Pena Llaca, Houston, TX (US)

(21) Appl. No.: 18/824,797

(22) Filed: Sep. 4, 2024

(51) Int. Cl. B64F 5/60; B64D 7/00; G01M 3/32

(52) U.S. Cl. CPC B64F 5/60; G01M 3/3281; B64D 7/00

(57) ABSTRACT

This invention is a robust pressure testing system designed for harsh environments with minimal user interaction and easy maintenance. It utilizes standardized electromechanical components and relay logic, avoiding custom elements to ensure long-term reliability and reduce obsolescence. The system operates at 24 VDC and accepts AC, internal battery, or external DC power, with overcurrent protection provided by fuses and breakers. It can pressurize and evacuate test volumes to user-specified levels, monitoring for leaks through pressure decay. The pneumatic system generates positive and negative pressures, controlled by electrically actuated valves, with filters and dryers preventing contamination. The instrumentation includes a pressure transducer and process timer for precise measurements, enhancing usability and adaptability in varied environments. Modular components and self-diagnostic features further improve system performance and compatibility.

### FIELD OF THE INVENTION

The present invention pertains to a B-52 Electronic Warfare (EW) Pressurizing Test Set, designed to perform pressure testing for airborne defense systems. The invention simulates environmental conditions encountered by aircraft during actual operations and facilitates the alignment of low-pressure system warnings.

### BACKGROUND OF THE INVENTION

Aircraft systems must undergo rigorous testing to ensure their functionality in various environmental conditions. In particular, the airborne defense systems on the B-52 require precise testing of the pressurization mechanisms to detect potential issues like leaks or faults in the onboard low-pressure systems. Traditional methods have limitations in their ability to simulate the full range of pressures the aircraft encounters. This invention addresses that by applying both positive and negative pressures, activating equipment like pressure pumps, and systems for fault and leak detection.

### SUMMARY OF THE DESCRIPTION

The present invention relates to a B-52 Electronic Warfare (EW) Pressurizing Test Set that replicates the aircraft's environmental conditions during operation. The Test Set is designed to pressurize the system and facilitate the alignment of low-pressure system warnings. The system operates by applying both positive and negative pressures to onboard equipment, including pressure pumps and systems for detecting faults and leaks.

### Mechanical Design:

The mechanical structure is optimized for durability in harsh environments and minimizes user interaction during the testing process. The design utilizes widely available commodity components that are easily maintainable and ensure long-term reliability.

### Electrical Design:

The electrical system is designed to minimize reliance on custom programmable elements, increasing the longevity and reducing risks associated with obsolescence. Standardized electromechanical components and relay logic ensure stable operation, while also allowing for battery-powered operation and the ability to handle a wider range of input voltages. Electrical failure detection is incorporated to maintain reliability in extreme conditions, along with onboard AC power conversion for wall operation.

### System Operation:

The system allows the test volume to be pressurized to a preset or user-defined level, with pressure decay monitored over time using an onboard pressure transducer and process timer. The system also supports evacuation, reducing pressure to a user-selected absolute value for specific testing requirements. Self-diagnostic functions are built in, and the system can operate under a variety of environmental conditions using modular, off-the-shelf components.

### Power System:

The system operates internally at 24 VDC and can accept power from three different sources:
1. Ac (100-240V, 50/60 hz)
2. Internal rechargeable Bren-tronics 24 VDC low-temperature-capable batteries
3. External 18-75 VDC via an Amphenol connector selector switch ensures only one power input is active at a time, routing power through onboard DC/DC converter for filtering and regulation. Overcurrent protection is provided through onboard fuses or thermal breakers. The battery allows for approximately 10 test cycles, each comprising a 2-minute pressurization period, an 8-minute leak test, and a 1-minute vacuum test.

### Pneumatic System:

The pneumatic system includes a pump capable of generating both positive and negative pressures. Electrically actuated pneumatic valves control the flow direction, allowing air to be pumped into or evacuated from the test volume.

Inline check valves prevent backflow through the pump when not in operation, and filters combined with a desiccant dryer protect against contamination by moisture or particulates. A pressure switch facilitates automatic operation at preset pressure levels, while a precision relief valve ensures safe pressurization limits. ISOLATE and BLEED valves allow for isolation and atmospheric normalization as needed.

### Instrumentation System:

The system is equipped with two key instruments to manage the testing process:
1. A high-precision, thermally compensated absolute pressure transducer that displays pressure in absolute inches of mercury.
2. A process timer that counts in seconds to monitor the elapsed time during testing.

This design combines mechanical and electrical robustness with modularity, ensuring effective functionality in extreme environments while maintaining the flexibility to address a range of testing requirements.

### BRIEF DESCRIPTION OF THE DRAWINGS

The present invention is depicted in a series of drawings, illustrating various aspects of the system:

FIG. 1: Mechanical design diagram, illustrating the layout and structure of the mechanical components.

FIG. 2: Side view of the mechanical design.

FIG. 3: Isometric view of the mechanical design, showing the spatial arrangement of the components.

FIG. 4: Mechanical design schematic, detailing the connections and flow paths of the pneumatic system.

FIG. 5: Electrical diagram for the instrumentation system, illustrating the configuration of the pressure transducer and process timer.

FIG. 6: Electrical diagram for the power system, showing the power input options and the DC/DC converter.

FIG. 7: Electrical diagram of the pump control system, showing how the pump is controlled and actuated.

FIG. 8: Layout of the diagnostic panel, detailing the self-diagnostic instruments.

FIG. 9: Electrical diagram of the main control circuit, showing the logic and relay-based control system.

FIG. 10: A top view of the controller panel, varied power sources. Electrical failure detection, AC power conversion, and modularity further ensure the system's durability in various environments.

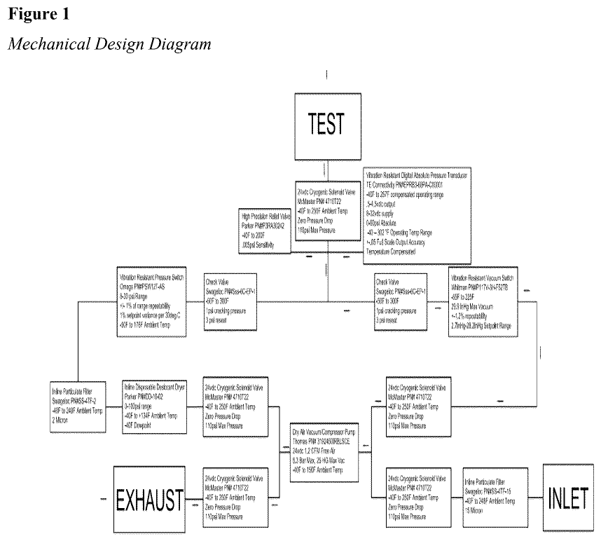

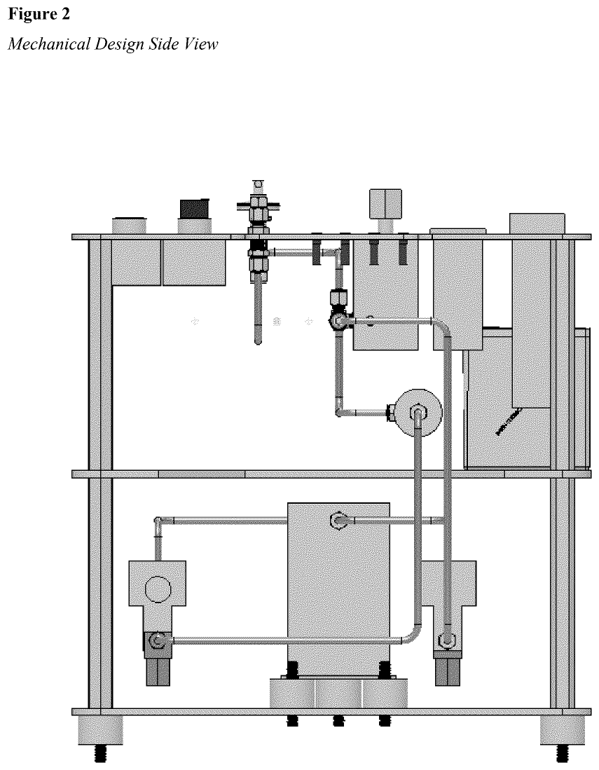

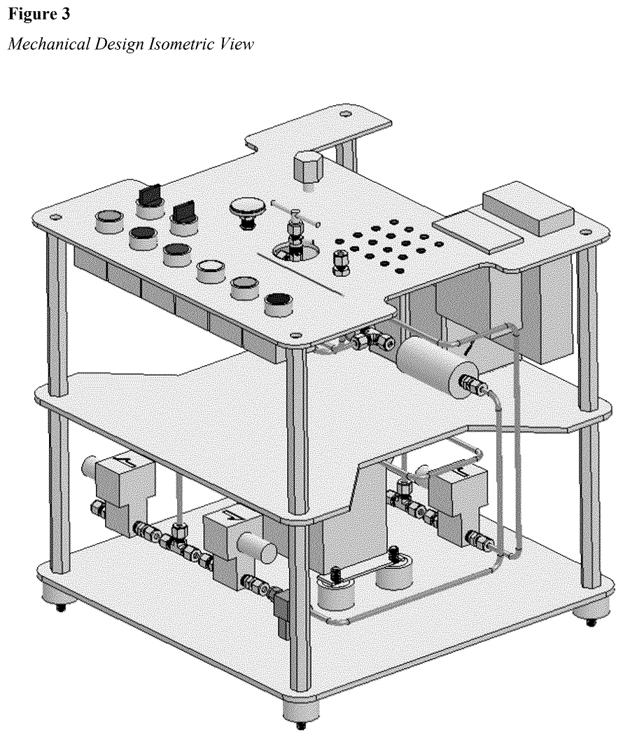

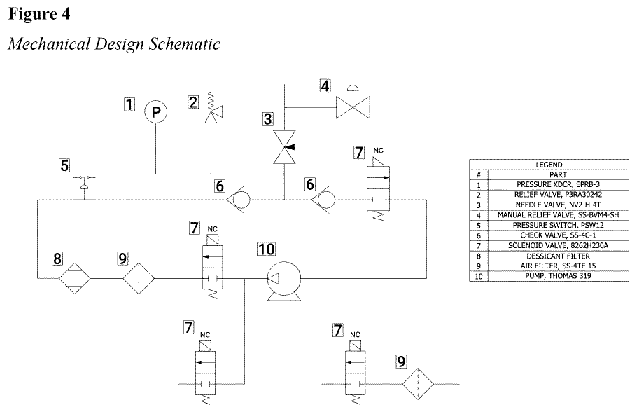

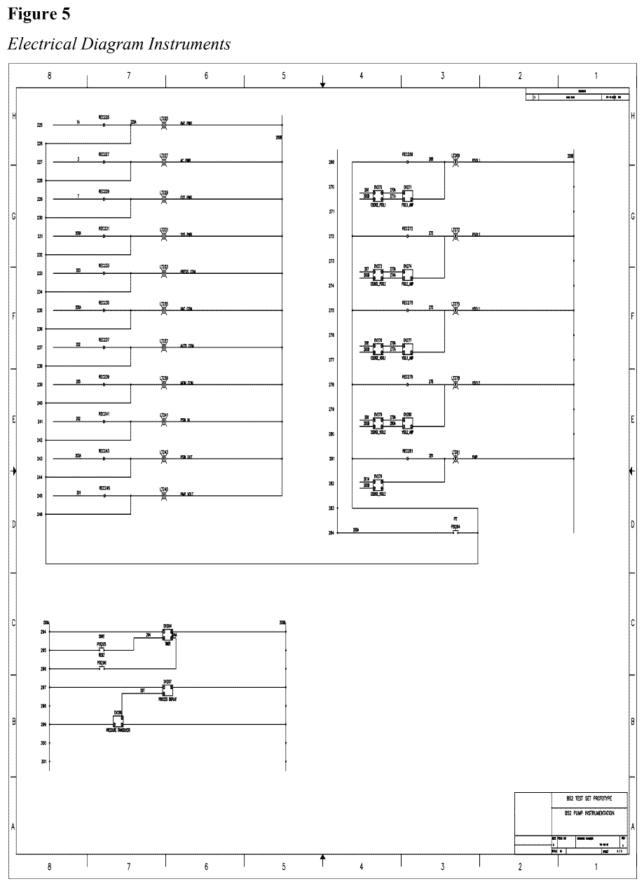

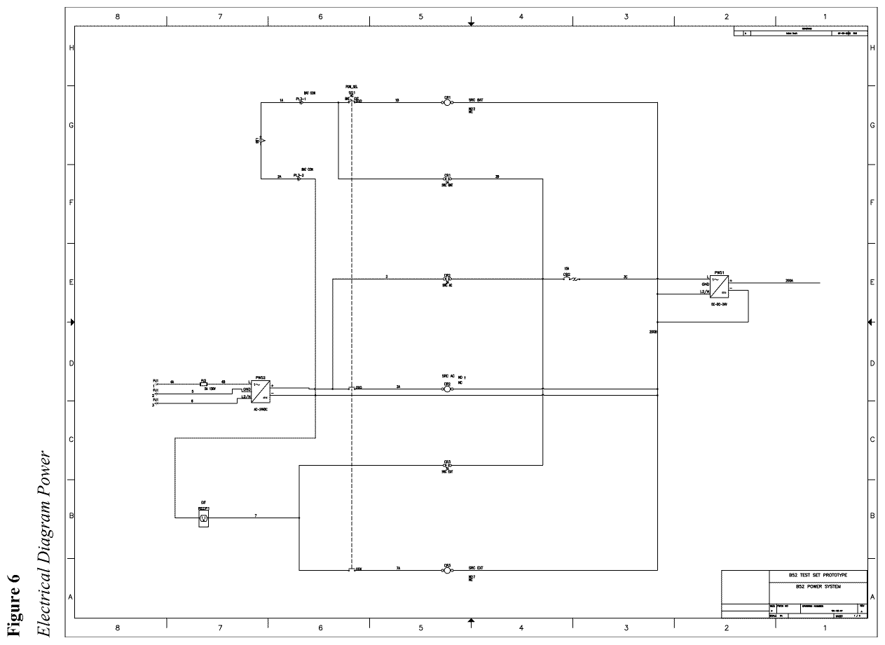

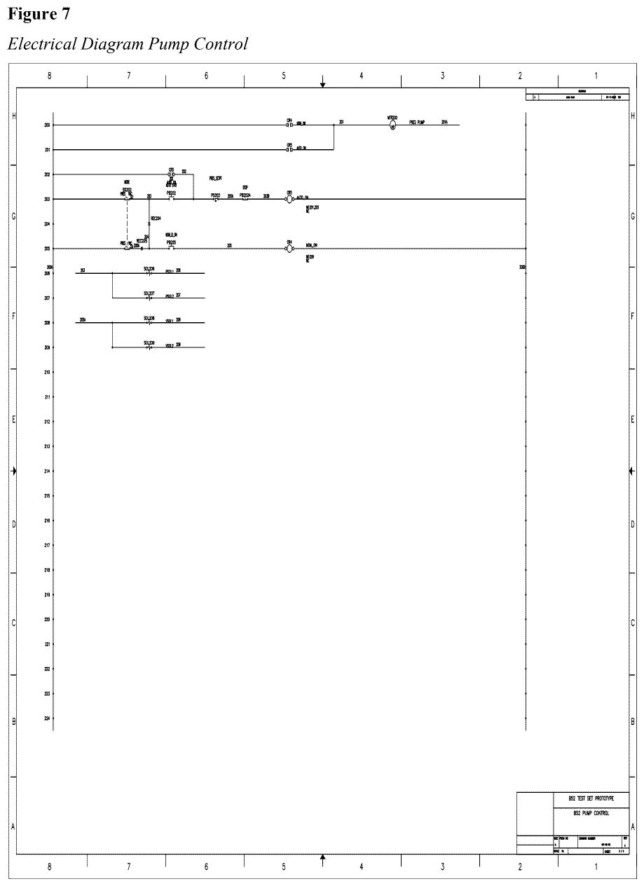

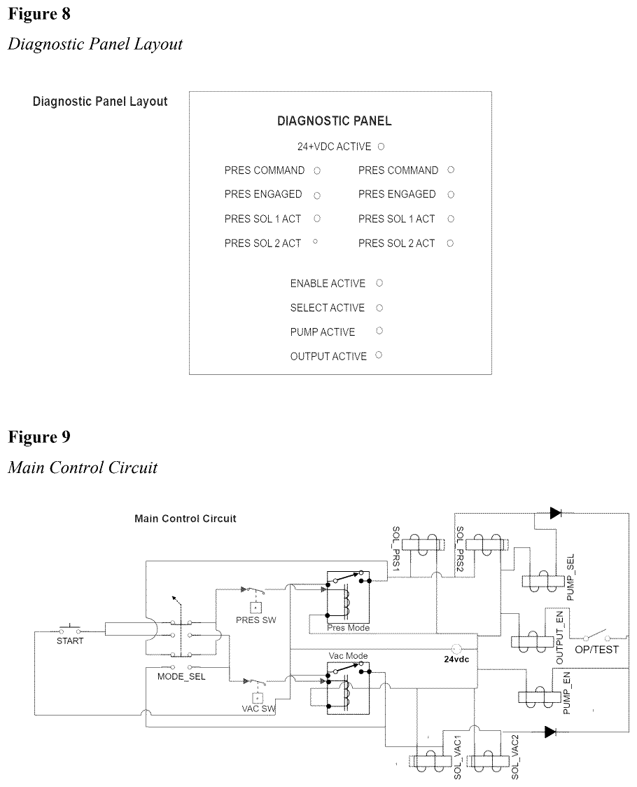

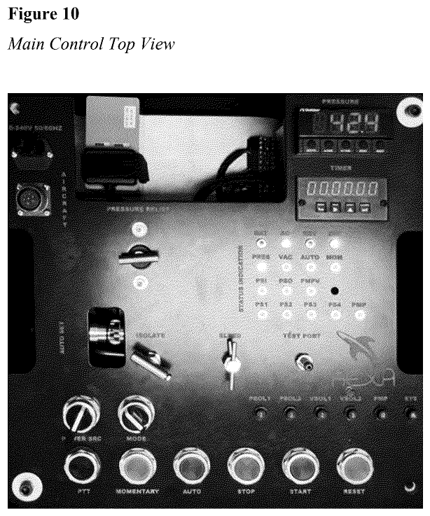

The system operation allows for controlled pressurization and evacuation of the test volume. The system can pressurize to a user-defined level and monitor for pressure decay, indicating leaks. It also allows the system to be evacuated, with pressure reduced to a user-specified absolute value, for more comprehensive testing. Self-diagnostic functions are included, and the system operates using modular components that ensure compatibility and maintainability.

The power system operates internally at 24 VDC and accepts three power sources, including AC (100-240V), internal rechargeable batteries, and external DC power via an Amphenol connector. The system's DC/DC converter ensures proper regulation and filtering, while overcurrent protection is provided via fuses and thermal breakers. The internal battery allows for 10 test cycles, ensuring the device can operate continuously in the field.

The pneumatic system features a pump capable of generating both positive and negative pressures. This pump is controlled by electrically actuated valves, allowing for air to be pumped into or evacuated from the test volume. Inline filters and a desiccant dryer prevent contamination, while a pressure switch and precision relief valve control pressurization. ISOLATE and BLEED valves allow for isolation and normalization as needed.

The instrumentation system includes a thermally compensated pressure transducer and a process timer, allowing for precise measurement and monitoring during testing. The

1. A method, system, or apparatus for performing pressure testing of airborne defense systems, comprising:
A system for applying positive and negative pressures,
A pneumatic system for controlling pressurization and evacuation of a test volume,
An electrical system for monitoring, regulating, and powering the device,
A power system accepting multiple power sources with built-in overcurrent protection,
And an instrumentation system for accurately displaying pressure and elapsed time during testing.
